(19) United States
(12) Patent Application Publication
(10) Pub. No.: US 2026/0216820 A1
(43) Pub. Date: Jul. 30, 2026

(54) OPTICAL DEVICE, OPTICAL SYSTEM, METHOD FOR MACHINING A SAMPLE BY MEANS OF LASER RADIATION, AND SAMPLE

(71) Applicant: SurFunction GmbH, Saarbruecken (DE)

(72) Inventors: Dominik BRITZ, Wallerfangen (DE); Bogdan VOISIAT, Dresden (DE); Andrés Fabián LASAGNI, Grumbach (DE)

(73) Assignee: SurFunction GmbH, Saarbruecken (DE)

(21) Appl. No.: 19/639,664

(22) Filed: Apr. 6, 2026

Related U.S. Application Data
(63) Continuation of application No. PCT/EP2024/077263, filed on Sep. 27, 2024.

(30) Foreign Application Priority Data
Oct. 6, 2023 (DE) 10 2023 127 357.4

(51) Int. Cl. B23K 26/067; B23K 26/06; B23K 26/062

(52) U.S. Cl. CPC B23K 26/0673; B23K 26/0608; B23K 26/0626

(57) ABSTRACT

An optical device for machining a sample via laser radiation in at least two machining steps. The device comprises at least one beam splitter, a first optical machining device, and a second optical machining device. The beam splitter is arranged such that a laser beam can be split into at least two partial beams. The partial beams can be oriented towards the sample such that the sample is machined in two machining steps. The optical device comprises a component for changing the power density, so that the power density of the first partial beam is greater than the power density of the second partial beam. The invention also relates to an optical system comprising the optical device, to a method for machining the sample, and to a sample machined via the optical device.

This nonprovisional application is a continuation of International Application No. PCT/EP2024/077263, which was filed on Sep. 27, 2024, and which claims priority to German Patent Application No. 10 2023 127 357.4, which was filed in Germany on Oct. 6, 2023, and which are both herein incorporated by reference.

### BACKGROUND OF THE INVENTIO

### Field of the Invention

The invention relates to an optical device, an optical system, and a method for machining a sample via laser radiation in at least two machining steps, along with a sample.

### Description of the Background Art

From the prior art, devices and methods for machining a sample via laser radiation are known in which the sample is structured via laser radiation in order to provide the sample with special surface properties, which is also referred to as surface functionalization. With respect to this, it is known to provide the sample with precise structure geometries using ultrashort laser pulses. As a result, however, irregular surface artifacts occur-for example, due to melting effects caused by the thermal interaction of the laser radiation used with the machined sample surface. A further example of such surface artifacts are laser-induced periodic surface structures (LIPSS) on the order of magnitude of the wavelength of the laser radiation used, which form as a result of the polarization of the laser radiation and depend upon the polarization direction of the ultrashort laser pulses. The surface artifacts are undesirable in a plurality of application cases, since they can lead to an impairment of the desired functionalization of the machined sample. A further disadvantage of the surface artifacts is that tribological effects are caused thereby, which impair the coefficient of friction of the machined sample.

Up to now, the mentioned undesirable surface artifacts and the disadvantages associated therewith have been accepted, since no possibility existed of reliably and efficiently eliminating the surface artifacts. Individual known solutions provide, for example, a mechanical post-treatment of the sample, e.g., via brushes, in order to smooth the sample as much as possible after machining via laser radiation. Furthermore, it is known to post-treat the sample via plasma treatment. However, all known methods for the subsequent machining of the machined sample exhibit low process stability, which prevents their industrial use. Since these methods machine the entire sample surface, spatial and/or intensity-selective machining of the sample is not possible. In addition, the post-treatment of the sample requires additional devices for the performance thereof, which results in an increase in costs. Furthermore, the known methods are associated with a considerable expenditure of time. Overall, all of the mentioned methods are therefore too complex for industrial use.

### SUMMARY OF THE INVENTION

It is therefore an object of the invention to eliminate the mentioned disadvantages and in particular to enable efficient post-machining of the sample, wherein, in particular, the sample is to be structured as desired and, at the same time, the properties of the machined sample are not to be impaired by undesirable surface artifacts.

The object of the invention is achieved, in an example, by an optical device for machining a sample via laser radiation in at least two machining steps is provided with at least one beam splitter, at least one first optical machining device, and at least one second optical machining device, wherein the at least one beam splitter is arranged such that a laser beam impinging on the optical device can be split into at least two partial beams, wherein the first optical machining device is arranged such that a first partial beam after the beam splitter and after passing through the first optical machining device can be oriented toward the sample in such a way as to machine the sample in the first machining step in a first machining region, wherein the second optical machining device is arranged such that a second partial beam after the beam splitter and after passing through the second optical machining device can be oriented toward the sample in such a way as to machine the sample in a second machining step in a second machining region, wherein the second machining region at least partially overlaps the first machining region, wherein the optical device has at least one component for changing the power density that is configured such that the power density of the first partial beam directed onto the sample is greater than the power density of the second partial beam directed onto the sample.

Furthermore, the object is achieved, in an example, by an optical system that has at least one laser and at least one optical device according to the invention, wherein the laser is configured to emit a laser beam that is oriented toward the optical device such that the sample can be machined in the at least two machining steps.

In terms of the method, the object is achieved in an example by a method that can comprise: providing a laser for emitting a laser beam, wherein the laser beam impinges on a beam splitter such that the laser beam is split into at least two partial beams, wherein a first partial beam after passing through a first optical machining device is oriented toward the sample in order to machine the sample in a first machining step in a first machining region, wherein a second partial beam after passing through a second optical machining device is oriented toward the sample in order to machine the sample in a second machining step in a second machining region, wherein the second machining region at least partially overlaps the first machining region, wherein the power density of the first partial beam directed onto the sample is greater than the power density of the second partial beam directed onto the sample.

The object is furthermore achieved in an example by a sample, which has been machined via an optical device according to the invention, in particular via an optical system according to the invention, and/or via a method according to the invention.

A fundamental idea of the invention is that, due to the splitting of the laser beam by the beam splitter into at least two partial beams and the subsequent guidance of the partial beams to the sample, only a single beam source is required in order to machine the sample in the at least two machining steps. For further machining, in particular in the form of post-machining of the sample in the context of the second machining step, no additional device is therefore required, which results in a cost saving and an overall acceleration of the machining of the sample. Furthermore, the machining of the sample in the context of the second machining step can occur in an intensity-selective and also spatially targeted manner in a particular region of the sample. This applies in particular if, in the sense of the invention, surface topographies that are disturbing for the application of the sample due to thermal interaction of the second partial beam with the sample are eliminated. One application with respect to this is the improvement of topographies on which LIPSS structures have formed as a result of the interferometric machining of the sample in the context of the first machining step, which are then thermally treated and eliminated in the result in the context of the second machining step-for example, by temporally longer pulse durations of the second partial beam. In this way, the surface topography of the sample can be substantially improved by the invention.

In the sense of the invention, in the context of the second machining step, undesirable surface artifacts that were formed in particular during the course of the first machining step can therefore be reliably machined. In particular, the machining of melt-morphological artifacts is possible.

Through the invention, a simple, versatile, compact, and efficient machining of the sample is enabled, wherein, in particular in the context of the second machining step, undesirable surface artifacts that may have formed in the context of the first machining step can be reliably and selectively eliminated. A further advantage of the invention is that only a single laser source is required, which substantially increases the efficiency of the invention. Furthermore, this results in a saving of installation space. The same applies to the optical system according to the invention and the method according to the invention.

In the sense of the invention, the power density of a laser beam corresponds to the spatial distribution of its power, thus its spatially distributed pulse energy divided by its pulse duration. In this respect, the power density can also be referred to as energy fluence. In other words, the power density corresponds to the spatial distribution of the pulse energy per temporal pulse duration of the laser beam. Relative to a particular power density of a partial beam, the power density can therefore be reduced, for example, by reducing the pulse energy and/or by increasing the temporal pulse duration.

“Sample” in the context of the invention refers to the object to be machined in the at least two machining steps. This can, for example, be a workpiece, but also a tool.

Preferably, the at least one component for changing the power density is the at least one beam splitter and/or the at least one first optical machining device and/or the at least one second optical machining device. For this purpose, the at least one beam splitter can be configured such that the splitting of the laser beam into the at least two partial beams does not occur with equal intensity, so that the intensities of the partial beams are not equal in each case. For example, the first partial beam after leaving the beam splitter can have approximately 55% to 80% of the intensity of the laser beam impinging on the beam splitter, whereas the intensity of the second partial beam after leaving the beam splitter has approximately 45% to 20% of the intensity of the laser beam impinging on the beam splitter. Corresponding considerations apply in the case of a splitting of the laser beam by the beam splitter into at least three partial beams, whose intensities thus may also not be equally distributed. In a development of the invention, one of the optical machining devices can be designed as the component for changing the power density such that, via a focusing element, e.g., a lens, the beam diameter of the partial beam can be changed in order to change the power density of the partial beam in this way. Alternatively or additionally, one of the optical machining devices can have a pulse-duration-changer in order to change the temporal pulse duration of the partial beam, so that in this way the power density of the partial beam can be changed.

In the sense of the invention, the parameter of the power density of a laser beam in particular comprises its peak power density, i.e., the temporal maximum of the spatial distribution of its (pulse) power. In this respect, it can preferably be provided that the component for changing the power density be configured such that the peak power density of the first partial beam directed onto the sample is greater than the peak power density of the second partial beam directed onto the sample. Corresponding considerations apply for all further features in relation to the power density, which can thus also comprise the peak power density.

Preferably, the component for changing the power density is configured such that the power density of the first partial beam is greater by at least a factor of 100 than the power density of the second partial beam. It can be provided that the pulse energy of the first partial beam be greater by at least a factor of 100 than the pulse energy of the second partial beam. Furthermore, it can be provided that the intensity of the first partial beam be greater by at least a factor of 100 than the intensity of the second partial beam. Furthermore, it can be provided that the pulse duration of the first partial beam be greater by at least a factor of 100 than the pulse energy of the second partial beam. In particular, it can be provided that the ratio between the power density and/or peak power density and/or pulse energy and/or intensity and/or pulse duration of the first partial beam and the power density and/or peak power density and/or pulse energy and/or intensity and/or pulse duration of the second partial beam be selected such that the first partial beam substantially causes ablation of the sample and the second partial beam substantially causes melting of the sample.

Preferably, the first optical machining device is configured for structuring the sample, in particular for periodic structuring of the sample, e.g., via interference of laser beams, and/or preferably the second optical machining device is configured for post-machining of the sample, in particular for topographical smoothing of the sample.

In the sense of the invention, the structuring of the sample in the context of the first machining step particularly comprises forming at least one indentation on the surface, facing the first partial beam, of the sample. By structuring the sample via the partial beam, it is ensured that the at least one indentation, in particular all formed indentations, are formed with identical dimensions within the manufacturing tolerance. The formation of the at least one indentation of the sample is therefore reproducible, in particular regarding the plurality of indentations of the first machining step and/or regarding the plurality of samples structured successively in the context of the first machining step.

For example, the structuring of the sample in the context of the first machining step can occur via a single partial beam, which is also referred to as “direct laser writing.” The use of at least two first partial beams can also be possible. For structuring the sample, the first partial beam can be focusable on the machining position of the sample via the first optical machining device in order to increase the energy density and power density. The first optical machining device can be configured such that the first partial beam can be moved relative to the sample, which is also referred to as rastering. This can occur, for example, via a laser scanner as a component of the first optical machining device, in particular via a mirror scanner that can be configured as a galvo scanner and/or as a polygon scanner. The laser scanner is preferably configured for one-dimensional or two-dimensional deflection of the first partial beam. In a further example of the invention, the sample can be translationally movable, relative to the first partial beam that is in particular spatially fixed-for example, via at least one servomotor and/or a conveyor belt. In a particularly advantageous development of the invention, the first partial beam and the sample can be moved one-dimensionally and/or two-dimensionally in order to enable the particularly rapid structuring of the sample.

In order to increase process efficiency, the first machining step can also provide the use of at least two first partial beams in the sense of the above-described “direct laser writing” during the first machining step, in order to structure the sample. In a development of the invention, for this purpose the first partial beam associated with the first optical machining device, which in this respect is also referred to as a “seed beam,” can be split into at least two first partial beams via the first optical machining device-for example, via a further beam splitter or a diffractive optical element. The at least two first partial beams obtained in this respect on the basis of the original first partial beam can be oriented toward the sample via the first optical machining device for structuring the sample, wherein it can be provided that at least one of the first partial beams, in particular a plurality of, preferably all, first partial beams, be or be able to be focused independently of one another toward the sample by the first optical machining device after passing through the latter. The at least two first partial beams can be oriented relative to one another in a particular spatial relation after passing through the first optical machining device, in particular when using at least one diffractive optical element as a component of the first optical machining device as already described.

Furthermore, it can be provided that the first optical machining device be configured such that the first partial beam can be split into at least two partial beams that can be oriented after passing through the first optical machining device such that the at least two partial beams interfere with one another in the first machining region of the sample and machine the sample. Preferably, the first optical machining device is configured such that the first partial beam can be split into exactly two partial beams.

A development of the invention provides that the optical machining device be configured such that the first partial beam can be split into three partial beams that can be oriented after passing through the first optical machining device such that the three partial beams interfere with one another in the first machining region of the sample and machine the sample. As a result, a structuring of the sample with indentations in a hexagonal pattern can be produced, for example. In this case, the structuring has three axes along the surface of the sample along which the indentations are arranged in each case in a lateral period, wherein, in the sense of the invention, in the hexagonal pattern the lateral periods for the three axes are identical in each case.

In addition, it can be provided that the first partial beam be able to be split into four partial beams that can be oriented after passing through the first optical machining device such that the four partial beams interfere with one another in the first machining region of the sample and machine the sample, in order to generate, for example, a square pattern of indentations when structuring the sample. It can be provided that the first partial beam be able to be split into at most nine partial beams that can be oriented after passing through the first optical machining device such that the at most nine partial beams interfere with one another in the first machining region of the sample and machine the sample.

Preferably, the first optical machining device is configured for structuring the sample via interference of at least two first partial beams in the context of the first machining step. Through the use of at least two first partial beams interfering with one another, a comparatively large first machining region of the sample can be machined in a comparatively short time, so that, in the result, the process efficiency of machining the sample is also improved. In particular, the sample can be provided in the context of the first machining step with a full-area surface structuring in the micrometer and/or nanometer scale range within a comparatively short machining time, which, compared to other known machining possibilities, leads to significantly higher process efficiency and thus lower manufacturing costs.

The first machining step can provide that the at least one indentation of the sample be generated with a dimension, in particular with a depth relative to an unstructured region of the effective surface, between 10 nm and 50 μm, in particular between 100 nm and 15 μm or between 1 μm and 25 μm. In further examples of the invention, the first machining step can provide that the dimension of the indentation correspond to its length in the x-direction and/or y-direction, wherein, in the sense of the invention, in the case of a plurality of indentations, the y-direction corresponds to the offset direction of the indentations, while the x-direction is arranged perpendicular thereto. The x- and y-directions are each perpendicular to the normal of the functional surface and therefore each extend along the functional surface. In the sense of the invention, the dimension can also be a direction as a combination of the x- and y-directions, which in this respect generally corresponds to a lateral direction.

In a further example of the invention, it can be provided that, in the context of the first machining step, at least two indentations with substantially identical dimensions, in particular with substantially identical depths, be generated. In the sense of the invention, two dimensions have substantially identical dimensions if the deviations therefrom do not exceed the machining tolerance that is customary in similar methods. At least two adjacent indentations can be arranged at a distance of 10 nm to 50 μm, in particular between 100 nm to 15 μm, or between 1 nm to 25 μm. Through the sample structured in this respect, structure geometries on the order of magnitude between 10 nm and 50 μm, in particular between 100 nm and 15 μm or between 1 μm and 25 μm, can be realized on the same sample at an industrially relevant process speed, while reproducibility is ensured.

Preferably, the first machining step provides that at least one group of indentations be generated on the sample in a periodic pattern, since this structure in particular is in particular easily producible via first partial beams interfering with one another. In the context of the present invention, the period refers to the distance between two identical structural features of different indentations of the periodic pattern, i.e., for example, the distance between the beginning of a first indentation of the periodic pattern and the beginning of the indentation adjacent to this indentation of the same periodic pattern. Alternatively or additionally, in the sense of the invention, the period can denote the distance between a center point of the first indentation of the periodic pattern and the center point of the indentation adjacent to this indentation of the same periodic pattern. Since the indentations of the periodic pattern are laterally offset, the invention also refers to the lateral period, which, as already mentioned, refers to the distance between recurring structural features of adjacent indentations of the periodic pattern.

Preferably, the first machining step provides that the group of indentations in the periodic pattern be generated on the sample with a lateral period between 10 nm and 50 μm, in particular between 100 nm and 15 μm or between 1 μm and 25 μm, in at least one direction along the effective surface. A periodic structuring of the sample in the context of the first machining step with a lateral period of this order of magnitude enables the formation of advantageous surface functionalities with which the sample is to be provided. The group of indentations in the periodic pattern can furthermore have different periods in different directions-for example, if three, four, or more first partial beams interfering with one another are used for structuring the sample. In an advantageous development, the group of indentations has identical periods in two different directions in the periodic pattern. Furthermore, it can be provided that the group of indentations have identical periods in three different directions in the periodic pattern, which corresponds, for example, to a hexagonal arrangement of the indentations. The group of indentations is formed, for example, as a sinusoidal line structure in which indentations and elevations are arranged one behind the other in the same lateral period each time.

The first machining step can provide that at least one group of indentations be generated on the sample with a linear course and/or with a rectangular, preferably square, base shape and/or with a circular base shape. The base shape of the indentations can be polygonal, in particular hexagonal. As a special case, the indentations can be designed as lines, which can be arranged in particular so as to be offset perpendicularly to their direction of extension and/or in a defined lateral period.

Preferably, the indentations, in particular the group of indentations, can have a lateral extent, in particular in a direction parallel to the direction of the lateral period, between 10 nm and 49 μm, in particular between 10 nm and 10 μm or between 1 μm and 25 μm, in order to obtain particularly advantageous anti-adhesion properties of the sample. Particularly preferably, all indentations in each case have a lateral extent of substantially 10 nm to 49 μm, in particular between 10 nm to 10 μm or between 1 μm and 25 μm.

Preferably, the indentations, in particular the group of indentations, can have an aspect ratio between 0.01 and 5, in particular between 0.01 and 1, wherein the aspect ratio in the sense of the invention corresponds to the ratio of the depth of the indentation to a lateral extent of the indentation.

In a development of the invention, the first machining step can provide that at least two first indentations, in particular a first group of indentations, be generated with a first lateral period between 10 nm and 50 μm, in particular between 100 nm and 15 μm or between 1 μm and 25 μm, and at least two second indentations, in particular a second group of indentations, be generated with a second lateral period, wherein, in particular, the second lateral period is smaller than the first lateral period. The first lateral period can be between 100 nm and 999 μm. However, the second lateral period can also be larger than or identical to the first lateral period. The second group of indentations may be mathematically similar to the first group of indentations such that the second group of indentations results from the first group of indentations via at least one mathematical similarity transformation-for example, translation, rotation, dilation, and/or scaling. Preferably, the second group of indentations corresponds to a rotation of the first group of indentations of 90° about an axis perpendicular to the tool surface.

Alternatively or additionally, the first machining step can provide that at least two first indentations, in particular a first group of indentations, be generated with a first dimension between 10 nm and 50 μm, in particular between 100 nm and 15 μm or between 1 μm and 25 μm, and at least two second indentations, in particular a second group of indentations, be generated with a second dimension, wherein the second dimension is in particular smaller than the first dimension. As already stated, in the sense of the invention, the dimension of the indentation may correspond to its depth.

In addition, the first machining step can provide that, in addition to the second indentations, at least two third indentations, in particular a third group of indentations, be generated with a third lateral period and/or a third dimension, wherein the third lateral period and/or the third dimension are in particular smaller than the second lateral period and/or the second dimension. In developments, the first machining step can provide that up to ten groups of indentations be generated, in each case with a lateral period and/or a dimension wherein, in particular, the lateral period and/or the dimension of one group are always smaller than the lateral period and/or the dimensions of the preceding groups.

Preferably, the first machining step provides that the region of the second indentations, in particular of the second group of indentations, at least partially overlap the region of the first indentations, in particular of the first group of indentations. The same applies to any third indentations that are created, in particular the third group of indentations. Through such an overlap, it becomes possible in the context of the first machining step to combine structures with different lateral periods and/or dimensions, in particular to superimpose them in the mathematical sense, and to provide the sample with complex surface structures that are not possible with simple structuring. In this way, the sample can be provided with improved anti-adhesion properties. In the sense of the invention, the first machining region corresponds to the union set of all indentations generated in the context of the first machining step.

Preferably, the first machining step provides that the first indentations, in particular the first group of indentations, and the second indentations, in particular the second group of indentations, be generated in a single working step or in separate working steps. The creation of the first indentations and the second indentations in a single work step results in an increase in processing speed. By contrast, the example in which the first indentations and the second indentations are generated in separate working steps particularly can mean that the sample is structured with different interference patterns. For example, it can be provided that the sample be or be able to be moved between two successive working steps in the context of the first machining step. Preferably, it can be provided that the sample be rotatable, or be rotated, between two working steps of the first machining step, in particular by an angle of 90°, so that indentations can be particularly easily formed, for example, as cross-structure patterns and/or so-called Penrose structure patterns. The indentations of the second group may be arranged perpendicularly to the indentations of the first group such that the lateral period of the second group of indentations is perpendicular to the lateral period of the first group of indentations. In addition, the lateral period of the second group of indentations can be parallel to the lateral period of the first group of indentations or can form an angle between 0° and 180°.

Preferably, the first machining step provides generation of the second group of indentations by a polarization of the at least one first partial beam, in particular of the at least two first partial beams, selected as a function of the material of the sample to be structured, as a result of which in particular laser-induced periodic surface structures can form, in particular in a common working step with the formation of the first group of indentations. The lateral period of the second group of indentations corresponds for example to at most the wavelength of the at least one first partial beam used. The polarization of the at least one first partial beam can be linearly oriented, wherein the polarization vector is arranged substantially perpendicular to the extension direction of the laser-induced periodic structures and/or parallel to the lateral period associated with the laser-induced periodic structures. In addition, the direction of the polarization vector of the at least one first partial beam can be oriented at an angle between 0° and 180° relative to the lateral period of the first group of indentations, so that, due to the orientation of the polarization vector of the laser beams, the arrangement of the second group of indentations is adjustable in particular relative to the first group of indentations.

For example, the first machining step can provide that the first indentations, in particular the first group of indentations, be generated via interference of the at least two first partial beams, wherein the second indentations, in particular the second group of indentations, are generated via interference of at least two further first partial beams and/or via a single further first partial beam. This can mean that the first indentations are always generated with the first partial beams interfering with one another, whereas this does not necessarily have to be the case for the generation of the second indentations. Generation of the second indentations via a single further first partial beam can be meaningful if the number of the second indentations is small compared to the number of the first indentations and/or if the region of the second indentations is small compared to the region of the first indentations. If the second indentations are also generated via further partial beams interfering with one another, it can be provided that the number of the further partial beams interfering with one another differ from or be identical to the number used for generating the first indentations.

Preferably, the first machining step provides generation of at least two groups of indentations in each case in a periodic pattern, wherein the lateral period of the first group of indentations is arranged relative to the lateral period of the second group of indentations at an angle not equal to 0°, in particular at an angle of 90°.

Post-machining of the sample may refer to processes in which the already existing topography of the sample, in particular generated in the context of the first machining step, is not substantially changed. For example, no significant enlargement, in particular enlargement of an already existing depth structure of the sample, occurs. In this respect, post-machining in particular does not correspond to renewed structuring of the sample, but, rather, the machining of the already existing structure of the sample. The second machining step comprises, for example, the removal of melt-morphological artifacts or the smoothing of the already existing topography. During the course of post-machining of the sample in the context of the second machining step, a significantly greater thermal interaction of the second partial beam with the sample can occur compared to structuring of the sample in the context of the first machining step.

Preferably, the at least one beam splitter can have at least one of the following components: mirror, partially translucent mirror, prism, biprism, wave plate, polarizer, power measuring device, beam profile measurer. As already mentioned, the beam splitter can be configured for splitting the laser beam into at least two partial beams with non-uniform intensities. In addition, in the sense of the invention, the beam splitter is not necessarily limited to the optical component for splitting the laser beam itself, but can furthermore comprise additional components, in particular a combination of the mentioned components.

The beam splitter can have a lambda/4 plate as a wave plate in order to change the polarization of the laser beam impinging thereon, in particular before the splitting thereof into the at least two partial beams. Via a lambda/4 plate, circularly or elliptically polarized radiation, for example, can be linearly polarized, and vice versa. Alternatively or additionally, the beam splitter can have a lambda/2 plate with which, in the case of linearly polarized radiation, the orientation of the polarization vector can be rotated in particular by a user-defined angle or, in the case of circularly polarized radiation, the helicity can be inverted so that, in this case, left-circular polarization becomes right-circular polarization, and vice versa. The polarization of the laser beam adjustable by the user via a polarizer, in particular via the wave plates, can be used for splitting the laser beam into the at least two partial beams-for example, in connection with a birefringent optical component. For splitting the laser beam into the at least two partial beams, the beam splitter can have in particular a partially translucent mirror that is configured, for example, such that the first partial beam is reflected at the mirror and the second partial beam passes through the mirror. In a similar manner, a prism, in particular a biprism, can be configured as a component of the beam splitter.

For analyzing the laser beam and/or at least one of the partial beams, the beam splitter can have a power measuring device that is configured in particular for determining the intensity of the laser beam and/or at least one of the partial beams. For characterizing the beam profile of the laser beam and/or at least one of the partial beams, the beam splitter can have a beam profile measurer that is configured for determining a parameter of the beam profile. For example, this is the parameter M², which corresponds to the beam quality factor or diffraction measure of a laser beam and indicates how close the geometry of the actually measured laser beam is to the model of the optimal Gaussian laser beam. In developments of the invention, it can be provided that the optical device, in particular one of the optical machining devices, have a power measuring device and/or a beam profile measurer.

The optical device can provide that the at least one beam splitter be configured such that the first partial beam after the beam splitter has a greater power density than the second partial beam.

Preferably, the optical device can have at least one component for modulating the pulse duration that is configured to change the pulse duration of the partial beam associated with the component for modulating the pulse duration. The component for modulating the pulse duration is preferably configured as a pulse expander that lengthens the temporal pulse duration of the partial beam associated therewith and passing through it. The pulse expander can be configured as a component of the second optical machining device and/or associated with the second partial beam. The component for modulating the pulse duration can be configured as a pulse compressor that shortens the temporal pulse duration of the partial beam associated therewith and passing through it. In this way, finer structures can be generated in the context of the first machining step. The pulse compressor can be configured as a component of the first optical machining device and/or associated with the first partial beam. Using a pulse expander as a component of the second optical machining device and/or using a pulse compressor as a component of the first optical machining device, it can be achieved that the power density of the first partial beam directed onto the sample is greater than the power density of the second partial beam directed onto the sample. In particular if the sample has been interferometrically machined by the first partial beam after passing through the first optical machining device, and particularly if the sample therefore has laser-induced periodic surface structures (LIPSS), the sample can be machined by the second partial beam after passing through the second optical machining device, whose power density according to the invention is lower than that of the first partial beam, with comparatively greater thermal interaction in order to improve the surface topography of the sample. This can occur approximately through melting effects that compensate for surface irregularities that are small relative to the dimensions of the surface topography. The same applies to droplets that have formed due to thermal interaction of the first partial beam with the sample in the context of the first machining step, which can then be eliminated in the context of the second machining step by the second partial beam.

Preferably, at least one of the optical machining devices can have at least one optical deflector in order to direct the partial beam associated with the optical machining device in the direction of the sample to be machined, wherein the at least one optical deflector is arranged in particular downstream of the component for modulating the pulse duration. In this respect, the optical deflector can be associated with the first partial beam as a component of the first optical machining device and/or with the second partial beam as a component of the second optical machining device.

Preferably, the at least one optical deflector can have at least one of the following components: laser scanner, galvanometer scanner, polygon scanner, optical focusing element. The optical deflector has, for example, at least one mirror and/or at least one lens, in particular at least one lens system, and can be oriented in such a way as to orient the partial beam associated with the deflector toward the sample to be machined. The at least one mirror and/or the at least one lens can be adjustable in such a way as to move the partial beam associated with the deflector relative to the sample. In this way, the sample can be easily machined in the context of the first machining step in the first machining region. The optical deflector can be configured for deflection of the partial beam associated with the deflector in at least one dimension, in particular in two dimensions. The optical deflector can be configured such that the partial beam associated with the deflector can be focused in a plane, wherein the focus plane can coincide with the surface of the sample to be machined. In a particularly advantageous development, the optical deflector has two mirrors, in each case tiltable about two axes, and a converging lens, wherein the configuration can also be referred to as F-theta optics or an F-theta objective. In a further example, the optical deflector can be configured as a galvanometer scanner. The optical deflector can have a mirror rotatable about an axis at which the partial beam associated with the optical deflector is reflectable. In a development of the invention, the mirror can have a polygonal base shape, which is provided with a mirrored surface. In this respect, the optical deflector can be configured as a polygon scanner, wherein the polygon scanner can have a galvanometer for moving at least one mirror. With the aid of the optical deflector, the sample can be machined in the context of the first machining step with the aid of a single partial beam, in particular structured. This is also referred to as “single-beam processing” or “single-beam direct laser writing.” The beam focuser of the optical deflector can have at least one lens, in particular a lens system, preferably a telescope.

Preferably, the optical deflector can have a beam splitter and a focuser arranged downstream of the beam splitter. The beam splitter is configured in particular to split the partial beam associated with the deflector into at least two partial beams, wherein these partial beams can be oriented toward the sample to be machined, e.g., via further deflector and/or focuser, in particular independently of one another. In this respect, the optical deflector can be configured as a multi-beam scanner with which the sample can be machined, in particular structured, with a plurality of partial beams in the context of the first machining step, which is also referred to as “multi-beam processing” or “multi-beam direct laser writing.”

Preferably, the first optical machining device, in particular the optical deflector, can be configured for the interferometric structuring of the sample. For this purpose, the optical deflector can have a beam splitter for splitting the partial beam associated with the deflector and at least one lens for focusing these partial beams in the direction of the sample, wherein the beam splitter and the lens are oriented such that the partial beams interfere with one another at least in the first machining region of the sample and structure the sample in particular over an area. This is also referred to as direct laser interference patterning (“DLIP”).

The second optical machining device can be configured for machining the sample in the second machining step via a single partial beam in order to machine the sample spatially in a targeted manner, so that, in particular, only spatially undesirable surface artifacts can be eliminated by the second optical machining device, without the sample having to be machined over its entire area in the context of the second machining step. In this respect, the second optical machining device can be configured for machining the sample via “direct laser writing.”

Preferably, at least one optical machining device can have a beam shaper that is configured to change the beam profile of the partial beam associated with the optical machining device. The beam shaper is configured, for example, to change a beam parameter of the partial beam representing the beam profile-for example, by expanding the beam diameter or reducing the same. The beam shaper can be configured to change the beam quality parameter of the partial beam, which is also referred to as M² and indicates how closely the partial beam corresponds to the theoretical model of a Gaussian laser beam. The beam shaper can be configured to convert an elliptical beam profile into a polygonal profile, in particular a rectangular profile, which is also referred to as a “top hat” profile. In addition, the beam shaper can be configured for the reverse conversion, in which a rectangular beam profile is converted into an elliptical beam profile. In particular, the second optical machining device has the beam shaper.

Further examples of the invention can provide that the first optical machining device be configured for machining the sample in the first machining step via one partial beam, via at least two partial beams, and/or via interference of at least two partial beams. The optical device can have a power determiner for determining the power of a partial beam, in particular of the second partial beam. The optical device can have at least one partially translucent mirror for splitting the second partial beam, wherein, in particular, it is provided that a power determiner be associated with the partially translucent mirror such that the power determiner is configured for determining the power of one of the partial beams. In particular, the power of the second partial beam can be determined therefrom.

The optical device can have at least one beam blocker that is configured to block at least one partial beam in particular in a user-defined manner such that the partial beam associated with the beam blocker does not impinge on the sample.

Preferably, the optical device has a lubrication device for applying a lubricant, in particular a grease-containing lubricant, to the sample, in particular after the first machining step of the sample. As a result, the coefficient of friction associated with the sample can be reduced, in particular after the second machining step, in the context of which heat can be applied to the lubricant.

Due to the structuring of the sample in the context of the first machining step, the surface thereof is enlarged in particular due to the at least one indentation and allows improved wetting of the sample by the lubricant. According to the knowledge of the applicant, the lubricant after application to the sample is drawn into the indentations of the sample by capillary forces occurring in the microstructure region and remains stored there at least temporarily. This improves the anti-adhesion properties of the machined sample, which thereby becomes usable for tribological applications.

Preferably, the grease-containing lubricant comprises at least one component of the following group: oil-containing lubricant, oil, edible oil, vegetable oil, sunflower oil, rapeseed oil, food-compatible chain oil, grease, food-compatible grease, vegetable grease, animal grease, synthetic grease, polyalkylene glycol, dry lubricant, food-compatible dry lubricant, solid lubricant, carbon-based lubricant, graphite. In the sense of the invention, lubricants that meet the classification H1 and/or the requirements of EC Directive 93/43 EEC can be considered food-grade. In the sense of the invention, lubricants are considered to be food-grade in particular if unintentional contact with food is possible and humanly tolerable. Food-grade lubricants can contain additives that are safe for human consumption and may be transferred to food only in limited quantities. The lubricant can be liquid or solid.

In particular, it can be provided that the preferably grease-containing lubricant be applicable to the sample such that the lubricant forms a planar surface, which improves the anti-adhesion properties of the sample.

Preferably, the optical device has a heating device for applying heat to the sample, in particular after application of the grease-containing lubricant to the sample by the lubrication device.

Due to the application of heat to the sample, thus through thermal treatment of the sample and of the lubricant applied thereto, polymerizations as well as oxidations and hydrolyses of the lubricant can occur in the context of the second machining step, in particular at least partial decomposition or cleavage of carbon groups due to the prevailing high energies. As a result, reaction products are deposited in the at least one indentation of the sample and adhere particularly well to the surface of the sample due to the already mentioned enlargement of the surface of the sample, so that the applied lubricant forms a lubricating film, which is also referred to as a tribofilm. Due to the structuring of the sample in the context of the first machining step, these properties are particularly durable and protect the sample as long as possible against mechanical wear. The machining of the sample occurs in an environmentally friendly manner and results in a durable sample with anti-adhesion properties that remain stable even after prolonged use. Furthermore, after the second machining step, no additional cleaning steps are required, so that the sample is immediately ready for use after completion of the second machining step (“ready to use”). Preferably, the heating device is configured for applying heat for a temporal duration of at least 1 min.

The machining of the sample in the context of the second machining step additionally results in the lubricant obtained and machined thereby being introducible into the structures of the sample formed due to the first machining step. When friction occurs between a component and the machined sample, the lubricant within the structures comes into tribological contact with the component, so that the friction properties of the sample are improved. This enables longer use of the machined sample.

The second optical machining device can be configured as the heating device. In addition, the heating device can be configured as a component separate from the optical machining devices.

Preferably, the beam splitter can be configured for splitting the laser beam impinging on the optical device into at least three partial beams, wherein a third optical machining device for machining the sample in a third machining step is associated with the third partial beam such that the third partial beam after passing through the third optical machining can oriented toward the sample in such a way as to machine the sample in the third machining step in a third machining region, wherein the third machining step occurs before the first machining step, wherein the power density of the third partial beam directed onto the sample is smaller than the power density of the first partial beam directed onto the sample. For splitting the laser beam into at least three partial beams, two beam splitters can be provided. In particular, it can be provided that the second beam splitter be associated with the third partial beam and/or the third optical machining device. The third machining step can be configured for pretreating the sample, in particular for thermally pretreating the sample, and can particularly comprise the leveling of topographical irregularities-for example, by melting effects. The third machining step can provide smoothing of the surface structure of the sample and/or pretreatment thereof before the first machining step. The power density of the first partial beam directed onto the sample can be the greatest relative to the power densities of the remaining partial beams directed onto the sample. The power density of the first partial beam directed onto the sample can be greater by at least a factor of 100 than the power density of the third partial beam directed onto the sample. The power density of the third partial beam directed onto the sample can be substantially equal to the power density of the second partial beam directed onto the sample. The third machining region can at least partially overlap the first machining region and/or the second machining region. The optical device according to the invention can be configured for use with the optical system.

The optical system can provide that the first partial beam have ultrashort pulses, wherein the laser is configured as an ultrashort-pulse laser. In particular, it can be provided that the temporal pulse duration of the first partial beam be at most 15 ps. As a result, it is ensured that thermal effects during the machining of the sample in the context of the first machining step are suppressed as far as possible, which improves the manufacturing quality of machining the sample. Furthermore, formation of melts and thermally induced material damage, in particular stress cracks, is largely prevented. It is known that, with shorter pulse durations, thermal effects are increasingly negligible, so that the sample can increasingly be machined mechanically. This effect is also referred to as cold ablation. Under this aspect, it can be provided that the temporal pulse duration of the first partial beam be at most 10 ps, so that even fewer thermal effects occur. In addition, the accuracy of machining the sample is improved. For the same reason, it can be provided that the temporal pulse duration of the first partial beam be at most 1 ps, as a result of which an even better machining quality of the sample machined after the first machining step can be obtained. Preferably, for the first partial beam, a temporal pulse duration between 100 fs and 15 ps, in particular between 100 fs and 1 ps, is provided.

Furthermore, the power of the first partial beam can be between 1 W and 5 kW, in particular between 1 W and 500 W, and/or the energy of the pulses of the first partial beam can be between 10 μJ and 200 mJ, in particular between 10 μJ and 100 mJ. The first partial beam can have a beam diameter between 2 μm and 6 μm when machining the sample in the first machining step. During the machining of the sample in the context of the first machining step, between 2 and 1,000 individual pulses can be superimposed within the first machining region in order to obtain high structure aspect ratios through correspondingly high material removal.

It can also be provided that the first partial beam can have pulse durations greater than 1 ns, in particular greater than 10 ns. In the case that undesirable surface artifacts arise due to melting effects, these can be eliminated in the context of the second machining step by machining the sample via the second optical machining device.

The laser can comprise at least one component of the following group, in particular be configured as a member of the following group: diode-pumped solid-state laser, e.g., Nd:YAG laser, disk laser, and/or fiber laser. The beam profile of the laser can at least partially be substantially Gaussian and/or rectangular, the latter also being referred to as a “top hat” profile.

The second partial beam particularly has a pulse duration of at least 10 ns, in particular at least 100 ns. As a result, surface artifacts that may have arisen in particular due to the machining of the sample in the context of the first machining step with ultrashort pulses can be thermally machined comparatively without significantly impairing the surface topography of the sample produced by the first machining step. In a development of the invention, the optical system particularly has only a single laser with which in particular a single optical device according to the invention is associated.

Preferably, the optical system has a first laser, a second laser, and an optical device according to the invention associated with both lasers. The laser beam of the first laser and the laser beam of the second laser can be oriented toward the optical device. The optical beam path of the first laser can at least partially overlap the optical beam path of the second laser, in particular in a partial region of the optical device. The laser beam of the first laser and/or the laser beam of the second laser can be activatable and/or deactivatable in a user-defined manner, e.g., via user-operable beam blocker that can comprise, for example, flip mirrors. The optical device can have a first component for changing the power density associated with the first laser and/or a second component for changing the power density associated with the second laser, wherein the first component for changing the power density can be configured to be complementary to the second component for changing the power density. For example, the first component for changing the power density can have a pulse compressor and/or the second component for changing the power density can have a pulse expander. The first optical machining device and/or the second optical machining device can be associated with the first laser and the second laser, so that a space-saving structure results. The power density of the first partial beam passing through the first optical machining device, which beam can be associated with the first laser or the second laser, can be greater than the power density of the second partial beam passing through the second optical machining device, which beam can be associated with the first laser or the second laser.

In terms of the method, it can be provided that the partial beam in each case not used for the current machining of the sample be able to be blocked in a user-defined manner, in particular with the aid of a beam blocker.

Preferably, the method according to the invention uses an optical device according to the invention, in particular an optical system according to the invention.

Preferably, the sample is moved between the first machining step and the second machining step in order to enable the efficient machining of the sample. As a result, the necessity of moving optical components is eliminated, which avoids the risk of misalignment thereof. The movement of the sample between the first machining step and the second machining step can occur over a distance of 1 mm to 20 mm in order to obtain a space-saving structure.

Preferably, the sample is structured in the first machining step, in particular structured via at least two partial beams, most preferably periodically and/or interferometrically structured. Alternatively or additionally, it can be provided that the sample be topographically smoothed, melted, and/or flattened in the second machining step.

Preferably, before the second machining step, a lubricant, in particular a grease-containing lubricant, is applied to the sample, in particular via a lubrication device, wherein, in particular, after the application of the lubricant, in particular during the second machining step, heat is applied to the lubricant. This can occur in particular due to the interaction of the second partial beam, after passing through the second optical machining device, with the sample during the second machining step.

The method can provide that, before the first machining step, the sample be machined with laser radiation in a third machining step, wherein, in particular, it is provided that the laser beam be split by the beam splitter into at least three partial beams, wherein the third partial beam passes through a third optical machining device and thereafter is oriented toward the sample such that the sample is machined in a third machining step in a third machining region, wherein the third machining region at least partially overlaps the first machining region and/or the second machining region, wherein the power density of the third partial beam directed onto the sample is smaller than the power density of the first partial beam directed onto the sample. In this respect, the third machining step can represent a type of pretreatment of the sample, as already explained above in connection with the corresponding device-related developments of the invention. All explanations with respect to the device-related developments of the invention apply correspondingly to the corresponding method-related developments.

Preferably, the sample has been machined via an optical system according to the invention and/or via a method according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of an optical system according to the invention with an optical device according to the invention in a schematic representation,

FIG. 2 shows representations of a sample structured with the optical system according to FIG. 1,

FIG. 3 shows a further example of the optical system according to the invention with an optical device according to the invention,

FIG. 4 shows representations of a sample structured with the optical system according to FIG. 3,

FIG. 5 shows a further example of the optical system according to the invention with an optical device according to the invention,

FIG. 6 shows representations of a sample structured with the optical system according to FIG. 5,

FIG. 7 shows a further example of the optical system according to the invention with an optical device according to the invention,

FIG. 8 shows representations of a sample structured with the optical system according to FIG. 7,

FIG. 9 shows a further example of the optical system according to the invention with an optical device according to the invention,

FIG. 10 shows representations of a sample structured with the optical system according to FIG. 9,

FIG. 11 shows a further example of the optical system according to the invention with an optical device according to the invention,

FIG. 12 shows representations of a sample structured with the optical system according to FIG. 11,

FIG. 13 shows a further example of the optical system according to the invention with an optical device according to the invention, and

FIG. 14 shows representations of a sample structured with the optical system according to FIG. 13.

### DETAILED DESCRIPTION

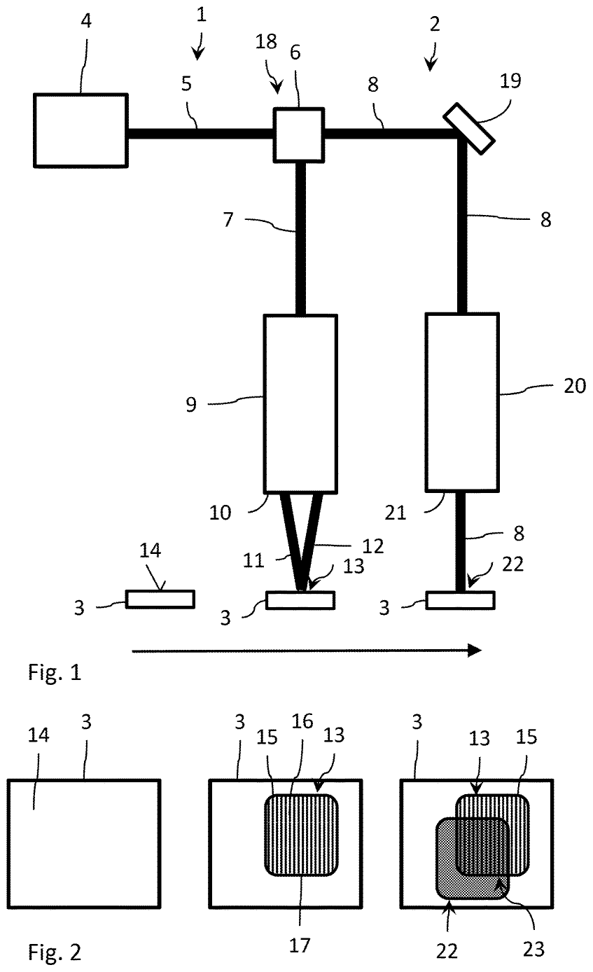

FIG. 1 shows, in a schematic structure, an optical system 1 according to the invention with an optical device 2 according to the invention for machining a sample 3 in two machining steps. For this purpose, the optical system 1 has a laser 4 that, in the example shown, is configured as an ultrashort-pulse laser and emits a pulsed laser beam 5 having a temporal pulse duration of 15 ps. The laser beam 5 of the laser 4 is oriented toward the optical device 2 such that the laser beam 5 impinges on a beam splitter 6 of the optical device 2, so that the laser beam 5 is or will be split into two partial beams 7, 8. According to FIG. 1, the first partial beam 7 is reflected by the beam splitter 6 in the direction of a first optical machining device 9 associated with the first partial beam 7, which is shown schematically in FIG. 1. The first optical machining device 9 has, as an optical deflector 10, a further beam splitter not shown in FIG. 1 for splitting the first partial beam 7 into two further partial beams 11, 12. The further partial beams 11, 12 are focused by a lens, not shown in FIG. 1, as a component of the optical deflector 10 in the direction of the sample 3 such that the further partial beams 11, 12 interfere with one another in a first machining region 13 on the surface 14 of the sample 3, as a result of which the sample 3 is machined, in particular structured, in the first machining step 13 by the first partial beam 7 in the form of the further partial beams 11, 12. The optical deflector 10 of the first optical machining device 9 is thus configured for interferometric structuring of the sample 3. For machining, the sample 3 is mechanically supplied to the interference region of the further partial beams 11, 12—for example, via a conveyor belt not shown in FIG. 1. Due to the interferometric machining of the sample 3 in the context of the first machining step, the sample 3 is machined over an area and provided with a periodic structure 15 that has line-shaped indentations 16 oriented parallel to one another. The indentations 16 are arranged offset relative to one another perpendicular to their direction of extension. The structure 15 has a rectangular indentation 17 with rounded corners surrounding the line-shaped indentations 16. The width, depth, and position of the indentations 16, 17 are adjustable by the user through a user-defined manipulation of the first partial beam 7, as are the position and the size of the first machining region 13 of the sample 3.

The portion of the laser beam 5 transmitted through the beam splitter 6 is the second partial beam 8 whose intensity, due to the configuration of the beam splitter 6 in the present example, does not correspond to the intensity of the first partial beam 7, but instead corresponds to only 30% thereof. In this respect, the beam splitter 6 is configured as a changer 18 for changing the power density. Already after leaving the beam splitter 6, the power density of the second partial beam 8 is therefore lower than the power density of the first partial beam 7. After the beam splitter 6, the second partial beam 8 impinges on a partially reflecting mirror 19, wherein only the reflected portion of the partial beam 8 is shown in FIG. 1. The partially reflecting mirror 19 is configured such that 99% of the intensity of the incident second partial beam 8 is reflected and the remaining 1% passes through the partially reflecting mirror 19. The portion of the second partial beam 8 passing through the mirror 19, not shown in FIG. 1, impinges on a power measurer, which is configured to determine the intensity of the partial beam impinging thereon. On this basis, the intensities of the second partial beam 8, its portion reflected by the mirror 19, the first partial beam 7, and also the laser beam 5 as a whole can be determined on the basis of the known intensity splitting ratios of the mirror 19 and the beam splitter 5. The portion of the second partial beam 8 passing through the mirror 19 also impinges on a beam profile measurer not shown in FIG. 1, which is configured for characterizing the beam shape and in this way enables the characterization of the beam shapes of the first partial beam 7, the second partial beam 8, and the laser beam 5.

The portion of the second partial beam 8 reflected at the mirror 19 is oriented toward a second optical machining device 20, which in FIG. 1 is arranged offset to the right of the first optical machining device 9. The second optical machining device 20 has a further optical deflector 21 not shown in FIG. 1, which in the present example is configured as a polygon scanner that has a mirror provided with a galvanometer and rotatable by means thereof, so that the second partial beam 8 after reflection at this mirror passes through the second optical machining device 20 such that the second partial beam 8 is deflected in the direction of the sample 3 and impinges thereon, since the sample 3 after the first machining step has been supplied to the second optical machining device 20. With the aid of the second optical machining device 20, the second partial beam 8 is guided along the sample 3 in a user-defined movement, so that the sample 3 is machined in a second machining step. In this case, the sample 3 is machined in a second machining region 22, which at least partially overlaps the first machining region 13. Due to the lower power density compared to the first partial beam 7, which is particularly expressed in a lower peak power density, the machining of the sample 3 occurs in particular in that surface artifacts formed as a result of the first machining step are eliminated by the second machining step. The surface 14 of the sample 3 is smoothed. This substantially improves the quality of machining of the sample 3. The movement of the sample 3 is illustrated by an arrow pointing to the right.

FIG. 2 shows in three representations the condition of the surface 14 of the sample 3 before the first machining step (left), after the first machining step (center), and after the second machining step (right). Before the first machining step, the surface 14, facing the optical system, of the sample 3 is substantially planar. After the first machining step, after the surface 14 of the sample 3 has been structured by the first optical machining device 9 with the interfering partial beams 11, 12, the surface 14 has the structure 15 shown in the center of FIG. 2. The structure 15 contains the already mentioned line-shaped, periodically arranged indentations 16 with a further rectangular indentation 17 surrounding them, which marks the first machining region 13 of the sample 3. After the second machining step, the sample 3 has been machined by the second optical machining device 20 by the second partial beam 8 in the second machining region 22, wherein the second machining region 22 overlaps the first machining region 13 but is not identical thereto. In the present example, the second machining region 22 is arranged offset downwards and to the left relative to the first machining region 13. The second machining step does not provide periodic structuring of the sample 3, which is illustrated in FIG. 2 in the right representation by the filled second machining region 22. In the overlap region 23 of the two machining regions 13, 22, the second machining step results in machining of the periodic structure 15 itself formed as a result of the first machining step, wherein it is smoothed and no longer contains undesirable surface artifacts.

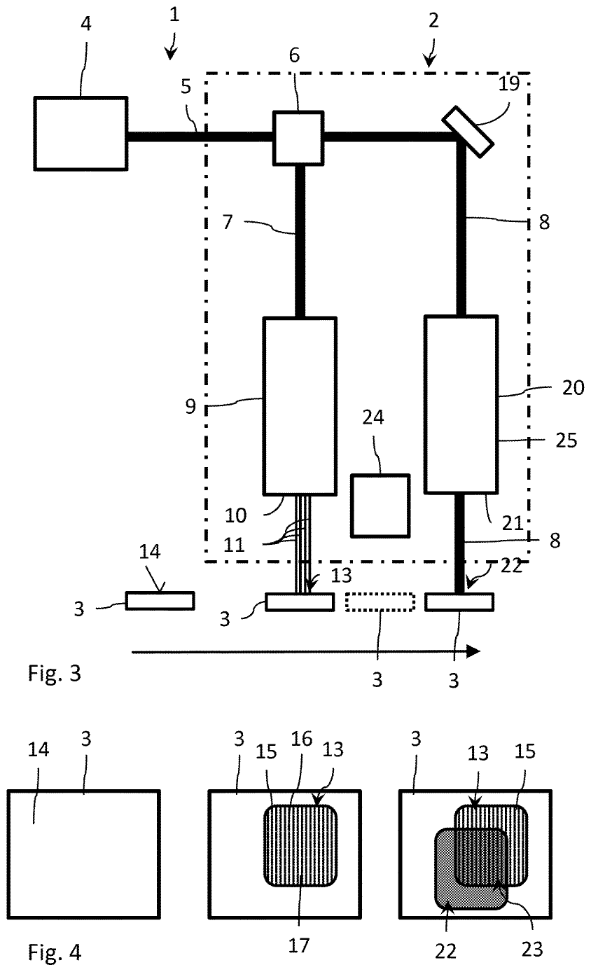

FIG. 3 shows an example of the optical system 1, wherein a dashed line designates the optical device 2. The optical system 1 according to FIG. 3 largely corresponds to the optical system 1 according to FIG. 1, in particular regarding the laser 4, the beam splitter 6, the mirror 19, and the second optical machining device 20. In contrast to the example of FIG. 1, the first optical machining device 9 according to FIG. 3 is not configured for the interferometric machining of the sample 3 in the context of the first machining step, but nevertheless has a beam splitter not shown in FIG. 3 for splitting the first partial beam as a component of the deflector 10. The partial beams 11 generated thereby are oriented toward the sample 3 after passing through the first optical machining device 9 by the deflector 10 not shown in FIG. 3, wherein the deflector 10 is configured as a polygon scanner. The partial beams 11 of the first partial beam 7 are oriented toward the sample 3 by the deflector 10 such that structuring of the sample 3 occurs in the context of the first machining step in the first machining region 13. This can also be referred to as “multi-beam processing” or “multi-beam direct laser writing.” In the context of the first machining step, the structuring of the sample 3 occurs which substantially corresponds to the structuring according to the example of FIG. 1. The sample 3 is provided in the position shown in FIG. 3 below the first optical machining device 9 for machining in the context of the first machining step.

After the first machining step, the sample 3 is supplied to a lubrication device 24 of the optical device 2 shown with dashed lines in FIG. 3, which is configured to dispense a grease-containing lubricant onto the sample 3 machined after the first machining step. After the sample 3 has been positioned below the lubrication device 24 in the position shown in FIG. 3, the lubricant, which in the present example is edible oil, is applied to the sample 3, so that the lubricant enters the indentations 16, 17 of the sample 3 and substantially wets the entire surface 14 of the sample 3 as uniformly as possible. This is attributable, for example, to capillary forces that arise due to the machining of the sample 3 in the microstructure region and draw the lubricant into the indentations 16, 17. The lubricant remains adhered there at least temporarily. The lubricant forms on the sample 3 an approximately planar layer with a thickness of 100 nm corresponding to the distance from an unmachined region of the surface 14 of the sample 3 to the surface of the lubricant layer.

The sample 3 is subsequently supplied to the second optical machining device 20 and machined thereby as already explained in connection with the example according to FIG. 1. An essential point here is that the second partial beam 8 also has a lower power density than the first partial beam 7, so that, in the context of the second machining step, in which the sample 3 is machined with the second partial beam 8, a substantially thermal interaction of the second partial beam 8 with the sample 3 occurs, and thus also with the applied lubricant. In this respect, the second optical machining device 20 is configured as a heating device 25. The temperature applied to the lubricant is selected in particular such that it lies below the smoke point of the lubricant—here, the edible oil—but is nevertheless sufficiently high to cause, for example, polymerizations, oxidations, and hydrolyses of the lubricant. Decomposition products of these reactions are deposited in the indentations 16, 17 of the structured sample 3, also referred to as microcavities, and adhere particularly well to the surface 14 of the sample 3 due to the enlarged surface resulting from the structuring, thereby forming a friction-reducing layer or film referred to as a tribofilm. This layer in combination with the structuring of the sample 3 in the micrometer range results in improved anti-adhesion properties and additionally improved corrosion properties of the sample 3.

FIG. 4 shows the condition of the surface 14 of the sample 3 before the first machining step (left), after the first machining step (center), and after the second machining step (right), wherein the lubricant applied to the sample 3 is not shown, so that FIG. 4 substantially corresponds to FIG. 2.

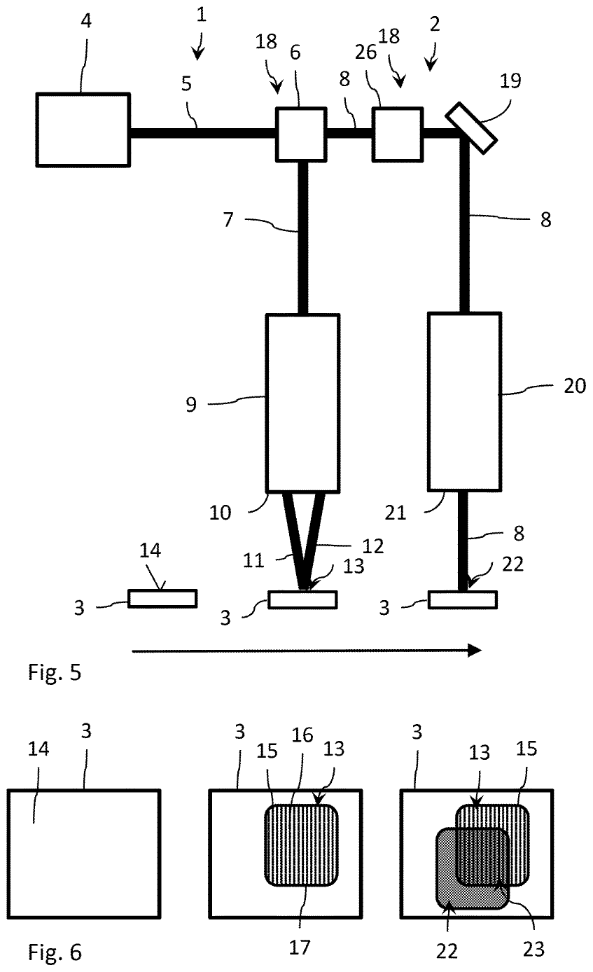

FIG. 5 shows a further example of the optical system 1 with the optical device 2, wherein the optical system 1 largely corresponds to the example according to FIG. 1. In particular, the first optical machining device 9 is configured for the interferometric machining of the sample 3 in the context of the first machining step, as already explained in connection with FIG. 1. Unlike FIG. 1, in FIG. 5, the mirror 19 is not partially translucent, but instead completely reflects the second partial beam 8 impinging thereon in the direction of the second optical machining device 20.

Between the beam splitter 6, which is still configured as the changer 18 for changing the power density, and the mirror 19, a further changer 18 for changing the power density of the optical device 2 is arranged in the form of a modulator 26 for modulating the pulse duration, which in the present example is a pulse expander 26 and increases the temporal pulse duration of the second partial beam 8 guided through the pulse expander 26, wherein the power density of the second partial beam 8 is reduced relative to the power density of the first partial beam 7. After the pulse expander 26, the second partial beam 8 impinges on the already mentioned completely reflecting mirror 19, from which the second partial beam 8 is guided in the direction of the second optical machining device 20 and passes through the same. The second optical machining device 20 is configured similarly to the example according to FIG. 1, so that the second partial beam 8 emerging therefrom is guided in the direction of the sample 3 and machines the same in the context of the second machining step as already described. FIG. 6 shows, similarly to FIG. 1 or FIG. 3, the condition of the sample 3 before the first machining step (left), after the first machining step (center), and after the second machining step (right).

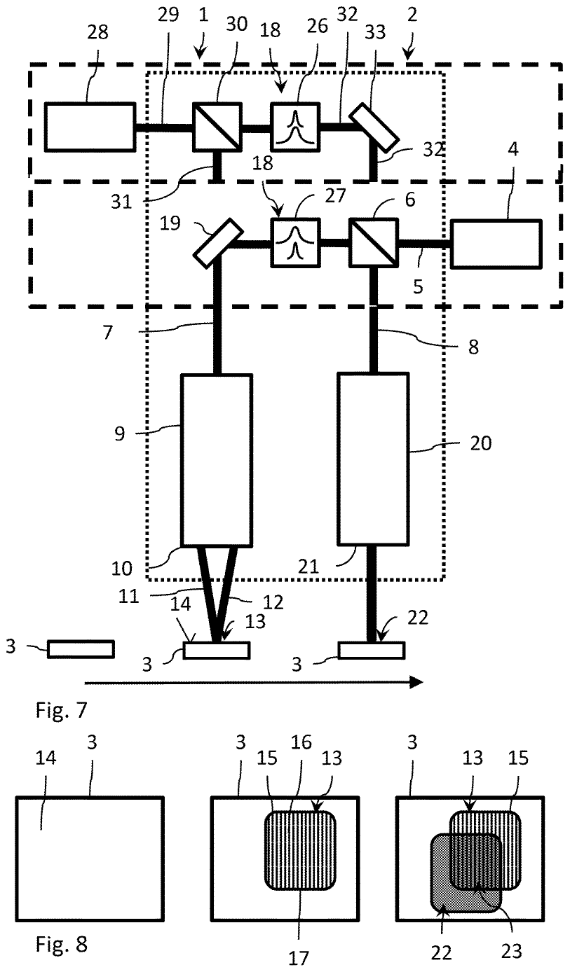

FIG. 7 shows a further example of the optical system 1 which comprises a first laser 4, a second laser 27, and an optical device 2. The first laser 4 is arranged on the right in FIG. 7 and emits a first laser beam 5 onto a first beam splitter 6 of the optical device 2 that, as already described, is configured for splitting the first laser beam 5 into a first partial beam 7 transmitted through the beam splitter 6 and a second partial beam 8 reflected at the beam splitter 6. The first partial beam 7 passes through a first component for changing the power density configured as a modulator for modulating the pulse duration in the form of a pulse compressor 27, so that the temporal pulse duration of the first partial beam 7 is shortened relative to the temporal pulse duration of the second partial beam 8. The first partial beam 7 is subsequently completely reflected at a first mirror 19, similarly to the example according to FIG. 5, and thereafter passes through the first optical machining device 9 in order to structure the sample 3 interferometrically in the context of the first machining step, as already explained above. The second partial beam 8 passes through the second optical machining device 20 for machining the sample 3 in the context of the second machining step, wherein the sample 3 is moved between the first machining step and the second machining step.

In addition to the first laser 4, the optical system 1 has the second laser 28, which is arranged in the upper right in FIG. 7 and emits a second laser beam 29 in the direction of a second beam splitter 30 as a component of the optical device 2. The beam splitter 30 is configured for splitting the second laser beam 29 into a third partial beam 31 and a fourth partial beam 32. The third partial beam 31 is reflected by the beam splitter 30 in the direction of the first optical machining device 9, so that, after passing through the same, the sample 3 is structured interferometrically in the context of the first machining step, similarly to the first partial beam 7 of the first laser 4. The fourth partial beam 32 passes through the beam splitter 30 in transmission and subsequently passes through the already described pulse expander 26 as a modulator for modulating the pulse duration. Thereafter, the fourth partial beam 31 is completely reflected by a second mirror 33 in the direction of the second optical machining device 20, after passing through which the fourth partial beam 32 is deflected in the direction of the sample 3 in order to machine the same in the context of the second machining step. Due to the pulse expander 26, the power density of the third partial beam 31 directed onto the sample after passing through the first optical machining device 9 is greater than the power density of the fourth partial beam 31 directed onto the sample.

In the example of FIG. 7, the sample 3 is not machined simultaneously by both lasers 4, 28. Instead, the optical system 1 shown there is functionally split such that the first beam splitter 6, the first component for changing the power density, viz., the pulse compressor 27, and the first mirror 19 are associated with the first laser 4, while the second beam splitter 30, the second component for changing the power density, viz., the pulse expander 26, and the second mirror 33 are associated with the second laser 28. These associations are indicated by the two dashed rectangles in FIG. 7. The first optical machining device 9 and the second optical machining device 20 are used jointly by both laser beams 5, 29, wherein the laser beam not used in each case is blocked in a user-defined manner by a beam blocker not shown in FIG. 7. Regardless of whether the sample 3 is machined using the first laser 4 or the second laser 28, the sample 3 is structured interferometrically in the first machining step via the first optical machining device 9 with that partial beam 7, 31 whose power density is greater compared to the other partial beam 8, 31 passing through the second optical machining device. FIG. 8 illustrates the surface of the sample before the first machining step (left), after the first machining step (center), and after the second machining step similarly to FIG. 6.

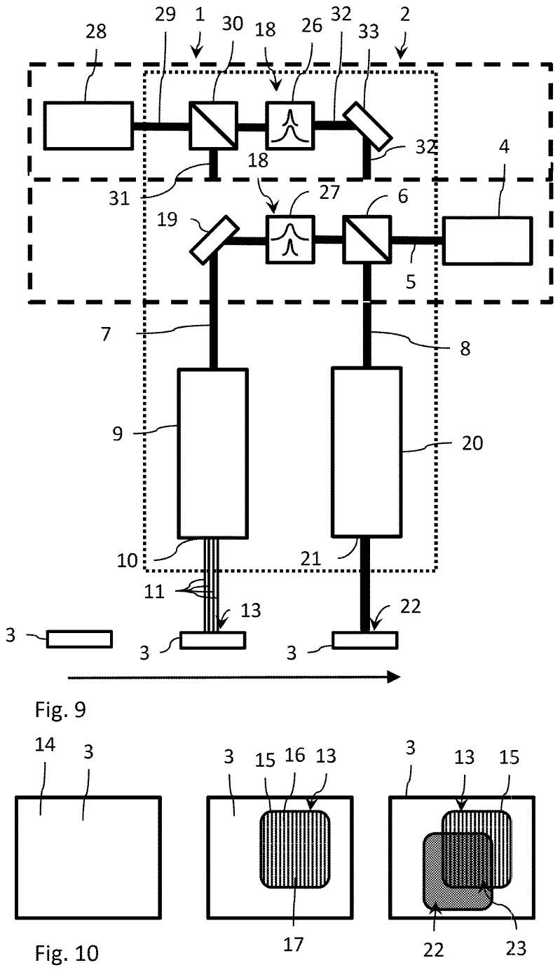

FIG. 9 shows a further example of the optical system 1, which substantially resembles the example according to FIG. 7, but wherein the first optical machining device 9 is not configured for the interferometric machining of the sample 3 as in FIG. 7, but instead for “multi-beam direct laser writing,” as already explained in connection with FIG. 3.

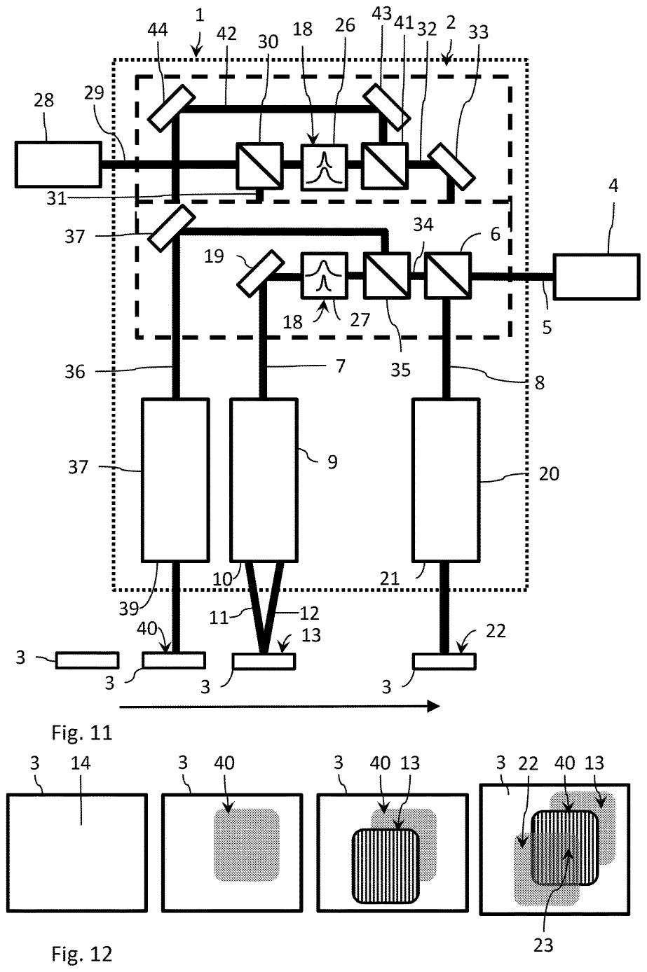

FIG. 11 shows a further example of the optical system 1, which largely corresponds to the optical system 1 of FIG. 7, but in contrast thereto initially machines the sample 3 in a third machining step before the first machining step occurs as already described. Similarly to the optical system 1 according to FIG. 7, the first laser 4 emits the first laser beam 5 that impinges on the beam splitter 6, wherein the second partial beam 8 reflected thereby passes through the second optical machining device 20 and machines the sample 3 in the context of the second machining step in the second machining region 22. The partial beam 34 passing through the beam splitter 6 impinges on a further beam splitter 35 associated therewith whose transmitted partial beam 7, as already described in connection with FIG. 7, after the pulse compressor 27, the mirror, and the first optical machining device, machines the sample 3 interferometrically in the first machining region 13 in the context of the first machining step in the form of the two mutually interfering partial beams 11, 12. The partial beam 36 reflected at the beam splitter 35, which beam, due to the arrangement of the beam splitter 35 upstream of the pulse compressor 27, does not pass through the same, is guided by a mirror 37 through a third optical machining device 38, which, in the example shown, is configured substantially analogously to the second optical machining device 20. After passing through the third optical machining device 38, the partial beam 36 is guided by a deflector 39 associated therewith onto the sample 3, such that the sample is thereby—initially—processed in the context of the third machining step in a third machining region 40. Thereafter, the sample 3 is machined in the context of the first machining step and subsequently in the context of the second machining step, as already described. Since, in the example shown, the third optical machining device 38 is configured substantially similarly to the second optical machining device 20, the power density of the third partial beam 36 directed onto the sample 3, in particular its peak power density, is substantially equal to the power density of the second partial beam 8, directed onto the sample 3, which passes through the second optical machining device 20. Furthermore, the power density of the third partial beam 36 directed onto the sample 3 is smaller than the power density of the first partial beam 7 directed onto the sample 3.

As in the example of FIG. 7, the sample 3 can not only be machined via the first laser 4, but also via the second laser 5, whose laser beam 29 impinges on the beam splitter 30 in the already described manner. The partial beam 31 reflected thereby passes through the first optical machining device 9 and machines the sample 3 in the form of the partial beams 11, 12 interferometrically in the context of the first machining step in the first machining region 13. The partial beam passing through the beam splitter 30 passes through the pulse expander 26 and thereafter impinges on a further beam splitter 40, wherein the partial beam 32 passing through the latter is guided by the mirror 33 onto the second optical machining device 20 as already described in connection with FIG. 7 and, after passing through the same. machines the sample in the context of the second machining step in the second machining region 22. The partial beam 42 reflected by the beam splitter 41 is guided by two mirrors 43, 44 onto the third optical machining device 37 and, after passing through the third optical machining device 37, impinges on the sample 3, which is thus machined in the context of the third machining step in the third machining region 40. The beam path associated with the second laser 28 is perspectivally overlapped by the beam path associated with the first laser 4, as already shown in FIG. 7.

In any case, similarly to the beam path of the first laser 4, the power density of the third partial beam 36 associated with the second laser 28 and directed onto the sample 3 is approximately equal to the power density of the second partial beam 32

associated with the second laser 28 and directed onto the sample 3, and is smaller than the power density of the first partial beam 31 associated with the second laser 28 and directed onto the sample 3.

FIG. 12 shows, in the left representation, the sample 3 with a surface 14 that is still unmachined. To the right thereof, the sample 3 has been machined in the context of the third machining step, which is illustrated by the third machining region 40. Since the power density of the laser radiation used in the context of the third machining step corresponds substantially to that of the second machining step, a substantially thermal pretreatment of the sample 3 occurs in the context of the third machining step, which is illustrated by the gray area in FIG. 12. Thereafter, as already described, the machining of the sample 3 occurs in the context of the first machining step in the first machining region 13, which partially overlaps the third machining region 40. Finally, the machining of the sample 3 occurs in the context of the second machining step in the second machining region 22, which partially overlaps the third machining region 40 and the first machining region 13. All machining regions 13, 22, 40 overlap in the overlap region 23.

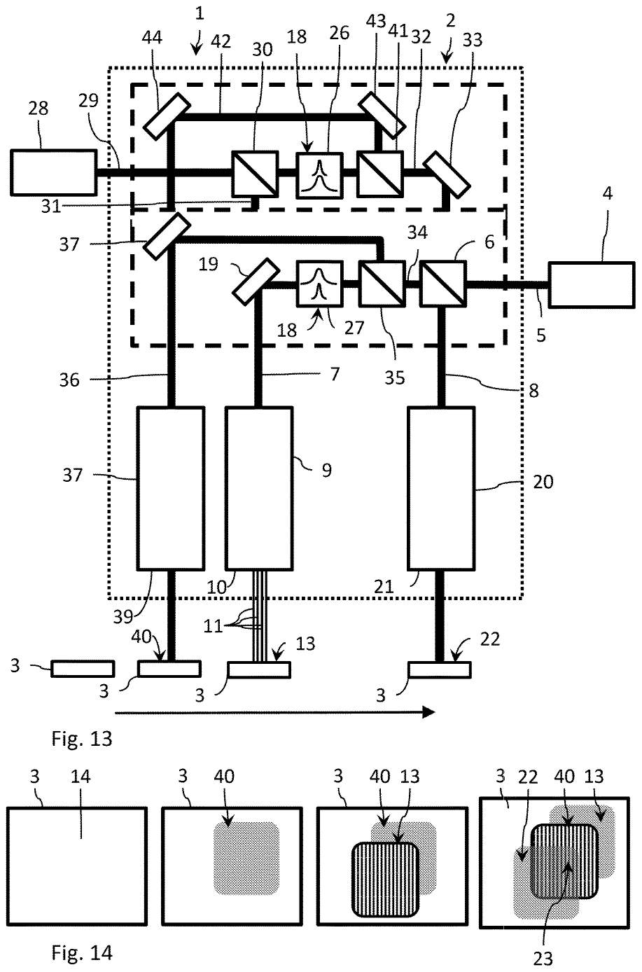

The example of the optical system 1 according to FIG. 13 corresponds substantially to the optical system 1 of FIG. 11, wherein, however, in contrast thereto, the machining of the sample 3 in the context of the first machining step is carried out, similarly to the example of FIG. 9, not interferometrically, but via “multi-beam direct laser writing,” as already described above. FIG. 14 shows the sample 3 in untreated form and in each case after the first, second, and third machining steps. The representations correspond largely to those of FIG. 12, so that reference is also made here to the above explanations.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An optical device to machine a sample via laser radiation in at least two machining steps, the optical device comprising:
at least one beam splitter arranged such that a laser beam impinging on the optical device is adapted to be split into at least two partial beams;
at least one first optical machining device arranged such that a first partial beam after the beam splitter and after passing through the first optical machining device is adapted to be oriented toward the sample in such a way as to machine the sample in a first machining step in a first machining region;
at least one second optical machining device arranged such that a second partial beam after the beam splitter and after passing through the second optical machining device is adapted to be oriented toward the sample in such a way as to machine the sample in a second machining step in a second machining region, the second machining region at least partially overlapping the first machining region; and
at least one changer for changing a power density that is configured such that the power density of the first partial beam directed onto the sample is greater than the power density of the second partial beam directed onto the sample.

2. The optical device according to claim 1, wherein the at least one changer for changing the power density is the at least one beam splitter and/or the at least one first optical machining device and/or the at least one second optical machining device.

3. The optical device according to claim 1, wherein the changer for changing the power density is configured such that the peak power density of the first partial beam directed onto the sample is greater than the peak power density of the second partial beam directed onto the sample.

4. The optical device according to claim 1, wherein the changer for changing the power density is configured such that the power density of the first partial beam is greater by at least a factor of 100 than the power density of the second partial beam.

5. The optical device according to claim 1, wherein the first optical machining device is configured for the structuring of the sample, in particular for the periodic structuring of the sample, and/or wherein the second optical machining device is configured for the post-machining of the sample or for the topographical smoothing of the sample.

6. The optical device according to claim 1, wherein the beam splitter comprises: a mirror, a partially translucent mirror, a prism, a biprism, a wave plate, a polarizer, a power measuring device, and/or a beam profile measurer.

7. The optical device according to claim 1, further comprising at least one modulator for modulating the pulse duration, which is configured to change a pulse duration of the partial beam associated with the modulator for modulating the pulse duration.

8. The optical device according to claim 1, wherein at least one of the optical machining devices has at least one optical deflector for directing the partial beam associated with the optical machining device in the direction of the sample to be machined, and wherein the at least one optical deflector is arranged downstream of the modulator for modulating the pulse duration.

9. The optical device according to claim 8, wherein the at least one optical deflector comprises: a laser scanner, a galvanometer scanner, a polygon scanner, and/or an optical focuser.

10. The optical device according to claim 8, wherein the at least one optical deflector has an optical beam splitter and a focuser arranged downstream of the beam splitter.

11. The optical device according to claim 8, wherein the optical deflector is configured for the interferometric structuring of the sample.

12. The optical device according to claim 1, wherein the at least one optical machining device comprises a beam shaper that is configured to change the beam profile of the partial beam associated with the optical machining device.

13. The optical device according to claim 1, wherein the optical device has a lubrication device for applying a lubricant or a grease-containing lubricant to the sample after the first machining step.

14. The optical device according to claim 1, wherein the beam splitter is configured for splitting the laser beam impinging on the optical device into at least three partial beams, wherein a third optical machining device for machining the sample in a third machining step is associated with the third partial beam such that the third partial beam after passing through the third optical machining device is adapted to be oriented toward the sample in such a way as to machine the sample in the third machining step in a third machining region, wherein the third machining step occurs before the first machining step, and wherein the power density of the third partial beam directed onto the sample is smaller than the power density of the first partial beam directed onto the sample.

15. An optical system for machining a sample comprising:
at least one laser; and
the at least one optical device according to claim 1,
wherein the laser is configured to emit a laser beam that is adapted to be oriented toward the optical device such that the sample is adapted to be machined in the at least two machining steps.

16. The optical system according to claim 15, further comprising a first laser and a second laser, wherein the first or second laser is associated with the optical device.

17. A method for machining a sample in at least two machining steps, the method comprising:
providing a laser;
emitting a laser beam via the laser, the laser beam impinging on a beam splitter such that the laser beam is split into at least two partial beams;
orientating a first partial beam after passing through a first optical machining device toward the sample in order to machine the sample in a first machining step in a first machining region; and
orientating a second partial beam after passing through a second optical machining device toward the sample in order to machine the sample in a second machining step in a second machining region,
wherein the second machining region at least partially overlaps the first machining region, and
wherein the power density of the first partial beam directed onto the sample is greater than the power density of the second partial beam directed onto the sample.

18. The method according to claim 17, wherein the optical device according to claim 1 orientates the first and second partial beam.

19. The method according to claim 17, wherein the sample is moved between the first machining step and the second machining step.

20. The method according to claim 17, wherein the sample is structured in the first machining step periodically and/or interfero-metrically structured, and/or wherein the sample is topographically smoothed, melted, and/or flattened in the second machining step.

21. The method according to claim 17, wherein, before the second machining step, a lubricant or a grease-containing lubricant is applied to the sample via a lubrication device, and wherein, after the application of the lubricant, during the second machining step, heat is applied to the lubricant.

22. The method according to claim 17, wherein, before the first machining step, the sample is machined with laser radiation in a third machining step, wherein the laser beam is split by the beam splitter into at least three partial beams, wherein the third partial beam passes through a third optical machining device and thereafter oriented toward the sample such that the sample is machined in a third machining step in a third machining region, wherein the third machining region at least partially overlaps the first machining region and/or the second machining region, and wherein the power density of the third partial beam directed onto the sample is smaller than the power density of the first partial beam directed onto the sample.

23. A sample machined via the optical device according to claim 1.
